(19) United States
(12) Patent Application Publication
(10) Pub. No.: US 2025/0128890 A1
(43) Pub. Date: Apr. 24, 2025

(54) Device For Handling Components

(71) Applicant: teamtechnik Maschinen und Anlagen GmbH, Freiberg (DE)

(72) Inventor: Jan MANGOLD, Tamm (DE)

(21) Appl. No.: 18/919,707

(22) Filed: Oct. 18, 2024

(30) Foreign Application Priority Data
Oct. 19, 2023 (DE) 10 2023 128 811.3

(51) Int. Cl. B65G 47/90; H01M 10/04

(52) U.S. Cl. CPC B65G 47/904; H01M 10/0404

(57) ABSTRACT

A device for handling components includes a carrier element and at least two magazines arranged thereon. Each magazine is displaceably held on the carrier element, and each magazine has a receiving unit with a plurality of receiving locations for one component each. A first drive unit is coupled to the carrier element to move a magazine into a filling position and into a transfer position. A filling unit is designed to bring a component into a receiving location of the magazine positioned in the filling position. Each receiving location is assigned a first element for lateral support of a component and a second element for vertical support of the component. The first element and the second element are displaceable relative to one another to bring the component held in the receiving location into a transfer position in which the component can be received by a downstream handling device.

### CROSS-REFERENCE TO RELATED APPLICATIONS

This application claims priority to German Patent Application No. DE102023128811.3 filed on Oct. 19, 2023, the entire disclosure of which is incorporated by reference.

### FIELD

The present disclosure relates to a device for handling components, in particular cylindrical battery cells. The present disclosure further relates to a device for relocating components, wherein the components are provided in particular by the aforementioned device, as well as a method for handling components.

### BACKGROUND

When manufacturing battery modules that have a large number of battery cells (hereinafter also referred to as “cells”), a large number of battery cells must be inserted into a receiving housing of the battery module in the correct pole position during a filling process. There are a number of solutions for this, which usually have in common the fact that a plurality of cells are inserted into the receiving housing at the same time.

Although this process has proven itself in practice, the desire remains to create a system that, on the one hand, operates with high throughput and, on the other hand, can be converted very flexibly and quickly to different applications. In this case, particular attention should be paid to different fillings of cells into receiving housings. If, for example, the arrangement of the cells within the receiving housing, and possibly also their pole position, changes, existing systems must be extensively modified.

Against this background, an object of the presently named inventors is to develop a device for handling components in such a way that it allows a high throughput and can be used flexibly and requires little or no modification effort in the event of changes in the arrangement of components in the end product.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This object is achieved by a device for handling components according to the present disclosure, a device for relocating components according to the present disclosure, a method for handling components according to the present disclosure, and a method for relocating components according to the present disclosure.

A device according to the present application for handling components, in particular cylindrical battery cells, has a magazine device which has a carrier element and at least two magazines arranged thereon, each magazine being held displaceably, preferably rotatably, on the carrier element and each having a receiving unit having a plurality of receiving locations for one component each, a first drive unit which is preferably coupled to the carrier element in order to move a magazine into a first position, filling position, and into a second position, transfer position, and a filling unit which is designed to bring a component into a receiving location of the magazine positioned in the filling position, each receiving location being assigned a first element for laterally supporting a component and a second element for vertically supporting the component, and the first element and the second element being displaceable relative to one another in order to bring the component held in the receiving location from a receiving position into a transfer position in which the component can be picked up by a downstream handling device.

In other words, this means that with the help of the at least two provided magazines, it is possible to fill one magazine and empty the other magazine at the same time. This means that the process of transferring components towards the end product takes place at high speed. In addition, it is possible to individually deliver the components into an end product, e.g. a battery module, without having to slow down the process of filling the first magazine.

In addition, filling the first magazine with individual components allows any subsequent alignment, in particular longitudinal alignment, e.g. pole position of a battery cell, in the end product, since the correct alignment can already be set during filling.

The object of the presently named inventors is thus completely achieved.

In a preferred development, a second drive unit is provided which is preferably provided in the region of the filling position and is designed to move, preferably rotate, at least the receiving unit of the magazine by one receiving location relative to the filling unit. Preferably, a third drive unit is provided which is preferably provided in the region of the transfer position and is assigned to the second element in order to displace the second element vertically and relative to the first element.

These measures have proven to be particularly advantageous. Providing a plurality of drive units that can operate independently of each other results in a high degree of flexibility of the device.

In a preferred development, the second drive unit and/or the third drive unit each have a coupling element which can be detachably coupled to a coupling counterpart. Alternatively, the second drive unit and/or the third drive unit are fixedly attached to the carrier element. Preferably, the coupling counterpart of the second drive unit is a cam disk, and the coupling element is a roller holder with one or more rollers, it being possible for the cam disk and thus the receiving unit to be rotated by one position by vertically moving the roller holder up and down. Further preferably, a shaft is provided which transmits the rotational movement of the cam disk to the receiving unit.

These measures have proven to be particularly advantageous. In particular, the use of a cam disk with external grooves in which rollers run leads to a mechanically very stable and precise rotational movement, the angle of rotation being fixedly predetermined by the grooves in the cam disk. This solution is extremely robust because, unlike digital solutions, no reference point needs to be determined.

In a preferred development, the coupling counterpart of the third drive unit is a support surface of a transmission element which cooperates with the second element of the receiving unit, and the coupling element is vertically displaceable so that the lifting movement of the coupling element causes a corresponding movement of the transmission element and thus of the second element. Preferably, the second element has a support unit with rods provided thereon, the transmission element being connected to the support unit. Further preferably, the transmission element is formed by the shaft. Preferably, the outer diameter of the rods is adapted to the inner diameter of the receiving locations.

These measures have also proven to be particularly advantageous. In particular, the mechanical structure for lifting the second element is simple and therefore cost-effective to implement. The adaptation of the second element to a changed number of receiving locations in the first element is also easily possible.

In a preferred development, the carrier element is designed as a rectangular plate on which two magazines are provided at opposite ends of the plate.

This measure has the advantage that a rectangular plate as a carrier element has a low mass and is therefore moved with low torque.

In a preferred development, the carrier element is designed as a round plate, more than two magazines being provided in an outer edge region of the plate, preferably at uniform angular distances from one another.

This measure has the advantage that a buffer of filled magazines is available so that the throughput can be increased.

In a preferred development, the first element is an annular element, each receiving location having at least partially vertically extending inner surfaces for lateral support of a component and being designed to be open at the top and bottom.

This measure allows a simple and cost-effective construction of the receiving unit.

The object of the presently named inventors is also achieved by a device for relocating components, the components being provided in particular by a device according to claim 1. The device has the following features: a handling device and a transfer magazine which can be coupled to the handling device and can be moved thereby in at least two dimensions, preferably three dimensions, the transfer magazine having: a receiving unit which has a plurality of receiving locations for components, in particular battery cells; an ejection unit which is designed to downwardly eject a component received in a receiving location; and a first drive unit which is designed to move the ejection unit and/or the receiving unit relative to one another in order to be able to assign the ejection unit to each receiving location.

One of the advantages of this device is that components can be placed individually into the end product so that different arrangements can be responded to at any time. It is therefore not necessary, for example, to adapt the transfer magazine to the new arrangement.

The object of the presently named inventors is also achieved by a method for handling components, which has the following steps:
inserting a plurality of components one after the other into individual receiving locations of a first magazine which is positioned in a first position, filling position, wherein after each insertion of a component, the first magazine is moved, in particular rotated;
transferring all components of a second magazine, which is positioned in a second position, transfer position, to a handling device during the filling of the first magazine; and
moving the filled first magazine to the transfer position and simultaneously moving the second emptied magazine to the filling position.

Furthermore, the object is also achieved by a method for transferring components, which has the following steps:
simultaneously transferring a plurality of components into a transfer magazine which is held by a handling device and positioned in a transfer position,
moving the transfer magazine over an end product having a plurality of receiving locations for components; and
delivering a single component in each case from the transfer magazine into a defined receiving location in the end product, and then moving the transfer magazine to the next receiving location, until all the components in the magazine have been delivered or the end product is completely filled.

The advantages of the methods according to the present disclosure correspond to the advantages of the devices according to the present disclosure so that a repetition can be dispensed with at this point.

It is understood that the features mentioned above and those to be explained below can be used not only in the combination specified in each case, but also in other combinations or on their own without departing from the scope of the present disclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram to explain the general structure of a system for filling an end product;

FIG. 2 is a perspective view of a filling station;

FIG. 3 is a perspective view showing an end product, in particular a battery module;

FIG. 4 is a schematic view of the system from FIG. 1;

FIGS. 5A and 5B are two perspective views of an indexed conveyor in two different positions;

FIGS. 6A and 6B are two perspective views of a turning unit as part of the system from FIG. 1;

FIGS. 7A through 7E are various views of a magazine device as part of the system from FIG. 1;

FIG. 8 is a perspective view of a handling device;

FIG. 9 is a perspective view of a transfer magazine as part of the system of FIG. 1;

FIG. 10 is a sectional view of the transfer magazine from FIG. 9; and

FIG. 11 is a perspective view of a unit with clamping elements.

In the drawings, reference numbers may be reused to identify similar and/or identical elements.

### DETAILED DESCRIPTION

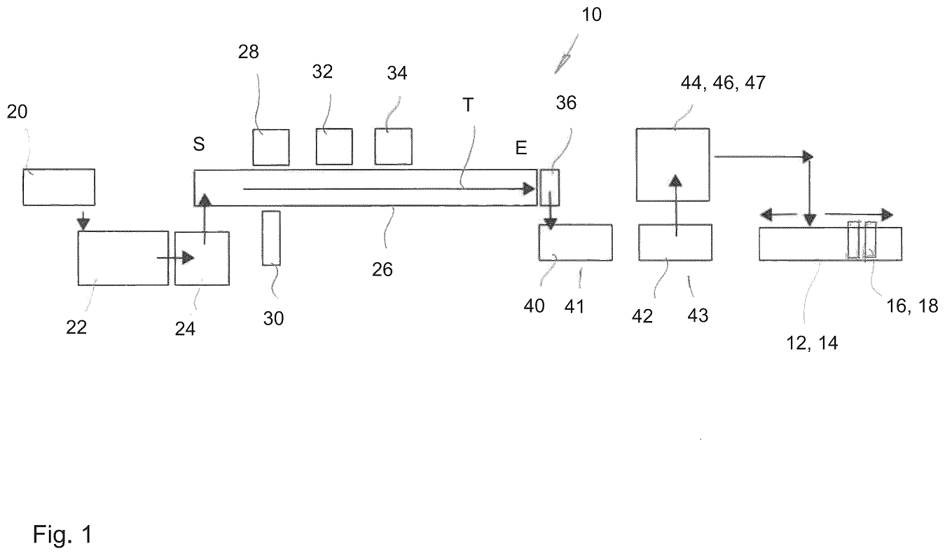

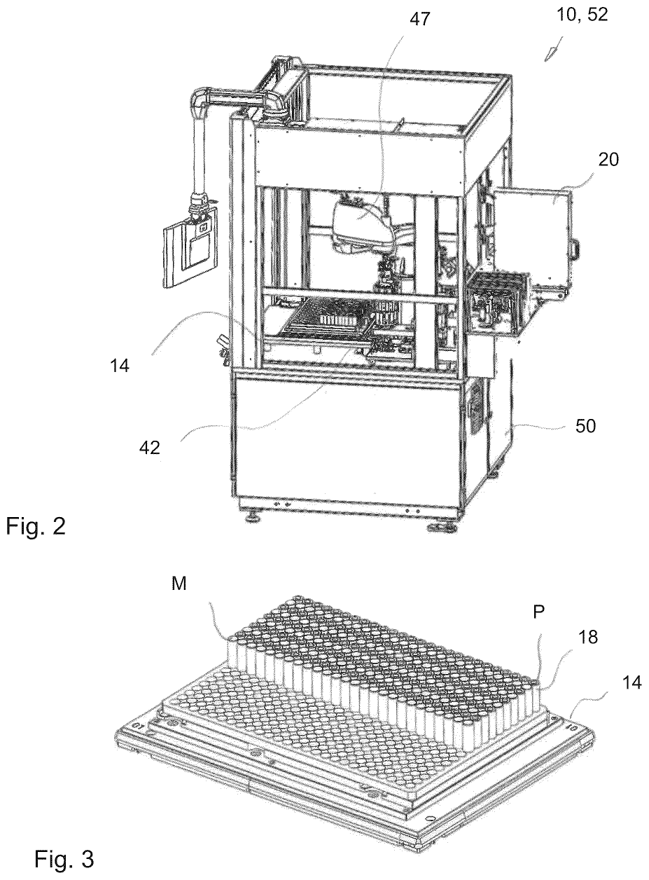

FIG. 1 is a schematic view of a system for filling an end product with components and is designated by the reference sign 10. The system 10 is shown in the form of individual functional blocks in order to more easily explain the process of filling an end product. Individual ones of these functional blocks are then explained in detail using the following FIGS. 2 to 11.

The system 10 serves in particular to fill an end product 12, in particular a battery module 14, with a plurality of preferably cylindrical components 16, in particular cylindrical battery cells 18 (hereinafter referred to as cells for short). If it is a battery module 14, the cells 18 are inserted into certain receiving locations with a certain pole position (positive pole or negative pole facing upwards). At this point, it should be noted that the term “component” does not only include battery cells, but also, for example, housings of a general nature such as housings for injection systems or syringe bodies, to name just two examples.

Although the system 10 is not only suitable for processing or handling the battery cells 18, reference will be made below only to this embodiment. However, it is understood that the system can also be used for other components, in particular cylindrical components.

The cells 18 are fed from outside the system 10 by means of a transport magazine 20. In this transport magazine 20, the cells 18 can be stored in an ordered or unordered manner with regard to their pole position. This does not matter for the system.

The individual cells 18 are taken out of the transport magazine 20 by a separating device 22 and guided to a pusher 24. The pusher 24 serves to transfer cells 18 one after the other, in a timed manner, onto an indexed conveyor (e.g., a belt) 26. This can be done, for example, by simply moving the cell 18 horizontally onto the indexed conveyor 26. The cells 18 are then located in designated receiving locations in the indexed conveyor 26 (explained in more detail below), the longitudinal axes of the cells 18 lying horizontally and at right angles to the transport direction.

The indexed conveyor 26 is designed such that it cyclically transports the individual cells 18 from one receiving location to the next subsequent receiving location until the cell 18 has reached an end region E or 27 of the indexed conveyor 26. The cells 18 are therefore transported in a timed manner from a start region S or 25 to the end region E or 27.

The number of receiving locations in the indexed conveyor 26 depends in particular on how many inspection and functional tests have to be carried out on each cell during transport. In the present embodiment there are for example three inspection or functional tests that are carried out on the cell 18.

For example, at the beginning of the indexed conveyor 26, there is a code reader 28 which reads a code printed on the cell for further processing. In order to be able to reliably read the code, a rotating unit 30 is provided at this receiving location, which rotates the cell about its longitudinal axis.

At the next receiving location of the indexed conveyor 26, a test unit 32 is provided which can carry out various electrical tests on the cell 18. In this case, for example the position of the negative pole or the positive pole is determined, and the electrical functionality of the cell is checked.

At the next receiving location of the indexed conveyor 26, a discarding unit 34 is provided which does or does not discard the cell, depending on the previous functional test. For example, the non-functional cell is pushed by a slider from the indexed conveyor 26 into a collecting container.

In the end region 27 of the indexed conveyor 26, the cell is transferred into a filling or turning unit 36 (hereinafter referred to simply as turning unit), which rotates the cell by 90° clockwise or counterclockwise depending on the previously determined pole position. After such a rotation, the cell 18 is in a vertical position and can thus, for example, be transferred downwards into a first magazine 40 located underneath. Preferably, the cell falls downwards under the force of gravity into a receiving location of the first magazine 40. It goes without saying that the first magazine 40 or the corresponding receiving location must be aligned with the turning unit 36.

The first magazine 40 is then moved so that the next receiving location is located under the turning unit 36 so that during the next cycle, the next cell can be rotated in the turning unit and then delivered downwards. By turning the cell in the turning unit by either 90° or −90°, the cell can be transferred in a controlled manner in either of the two pole positions, i.e. with the positive pole facing up or down.

This process is repeated until preferably all receiving locations in the first magazine 40 are filled with cells 18.

While cells 18 are being inserted into the first magazine 40, all cells 18 in a second magazine 42 which was previously filled are transferred to a transfer magazine 44. This transfer magazine 44 is adapted to the first or second magazine 40, 42 in such a way that receiving locations for cells 18 are positioned in the same way as the receiving locations in the two magazines 40, 42. In other words, if the transfer magazine 44 is accordingly aligned with the second magazine 42, the cells 18 from the second magazine 42 can be pushed for example upwards into the corresponding receiving locations of the transfer magazine 44, for example.

The transfer magazine 44 is detachably attached to a handling device 46, for example in the form of a robot 47. After the transfer magazine 44 has been filled with the cells 18, the handling device 46 guides the transfer magazine 44 to the battery module 14 and inserts each cell individually into the receiving location provided in the module.

With the help of the handling device 46, it is possible for the battery module 14 itself to be positioned stationarily in the system 10 and for only the transfer magazine 44 to move, i.e. to be displaced from receiving location to receiving location in the battery module 14. As soon as all cells 18 have been delivered from the transfer magazine 44, the transfer magazine 44 is moved back to the second magazine 42 by the handling device 46.

It can therefore be seen that the first magazine 40, which is located in a filling position 41 for being filled by the turning unit 36, is filled step-by-step or cyclically and then, when the desired filling level is reached, is moved into a transfer position 43, which is spaced from the filling position 41. In this transfer position 43, the first magazine 40 is then preferably completely emptied all at once. The second magazine 42 previously located in the transfer position 43 is then brought into the filling position 41. In other words, the two existing magazines 40, 42 always change their positions when the magazine in the filling position 41 is preferably completely filled with cells 18.

At this point, however, it should be noted that the system 10 can also

have more than the two shown magazines 40, 42. If more than two magazines are present, the magazine does not move directly from the filling position 41 to the transfer position 43, but is moved beforehand into one or more waiting positions.

Some of the functional blocks explained above are described in detail below. In this case, a technical design of the function block is presented by way of example, and it should be noted at this point that the aforementioned functions of the function blocks can of course also be achieved by other technical means.

In FIG. 2, the system 10 is accommodated in a housing 50 to form a filling station 52. This filling station 52 can be part of a larger system that is formed from a plurality of stations. For example, a station can be provided in each case before and after the filling station 52, the stations then being connected to one another via a transport device. On this transport device, the battery module 14 can be transported through the various stations, for example the battery cells 18 being inserted in the filling station 52 and an electrical connection of the individual cells then being possible in a subsequent station.

FIG. 2 shows the transport magazine 20 which can be inserted into a corresponding holder from the outside. This transport magazine 20 is filled with the cells 18, the pole position of the cells being irrelevant in this case.

Also visible is the robot 47 which takes the cells from the second magazine 42 and inserts them into the battery module 14. FIG. 3 shows a structure, by way of example, of the battery module 14, receiving locations being provided in a plate or a battery module housing for receiving the cells 18. It can be seen that the pole positions P, M of the cells 18 are ordered but not identical. For example, rows of cells with the positive pole facing upwards alternate with rows with the negative pole facing upwards. However, this orientation of the pole positions is always application-specific and can vary accordingly. Due to the fact that the pole position can be determined via the test unit 32, the system 10 knows in which direction the turning unit 36 has to turn the corresponding cell in order to ultimately achieve the correct pole position in the battery module 14.

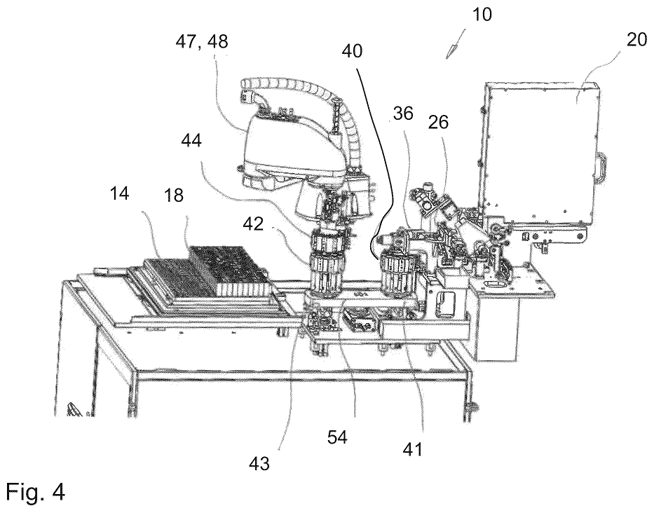

In FIG. 4, the filling station 52 is again shown without the surrounding housing 50. Clearly visible here are the two magazines 40, 42, which are provided on a beam-shaped or rectangular carrier element 54. This carrier element 54 is mounted so as to be rotatable about a vertical axis, so that the magazines 40, 42 can be moved back and forth between the filling position 41 and the transfer position 43. Preferably, the carrier element is rotated by approximately 180° in each case, so that the filling position 41 and the transfer position 43 are spaced approximately according to the length of the carrier element and lie on one line.

Furthermore, this figure shows the turning unit 36 which is arranged above the first magazine 40, which is in the filling position 41, so that a cell can fall downwards into a holder of the first magazine 40.

Finally, FIG. 4 shows that the transfer magazine 44 on the robot 47 is located directly above the second magazine 42, the transfer magazine 44 preferably having precisely as many receiving locations for cells as the second magazine 42. In order to transfer the cells 18 located in the second magazine 42, the corresponding receiving locations of the two magazines 42, 44 are aligned with each other so that the cells from the second magazine 42 can be pushed upwards into the receiving locations in the transfer magazine 44. This process and the corresponding design of the two magazines will be explained in detail later.

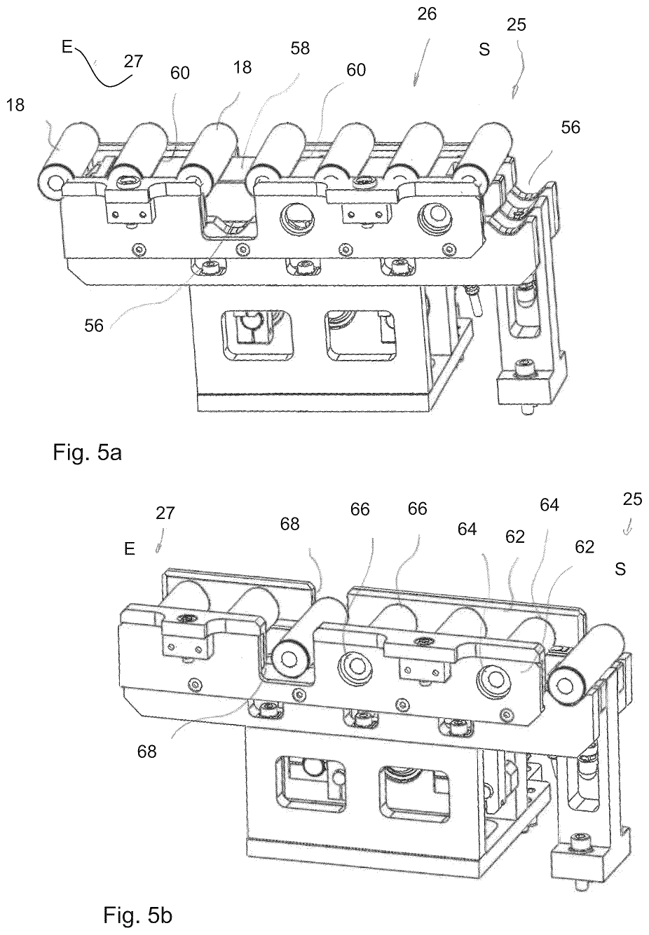

In FIGS. 5a and 5b, the indexed conveyor 26 is shown in greater detail. As already briefly mentioned above, the indexed conveyor 26 serves to cyclically transport cells 18 from the start region 25 to the end region 27, the cells being placed in receiving positions 56 provided for this purpose after each cycle. In the present embodiment, the indexed conveyor 26 has a total of seven of the receiving positions 56 which are provided at equal distances in the transport direction.

The transport itself takes place via a cell carrier 58, which also has holders 60 for cells 18. In the present embodiment, the cell carrier 58 has a total of six holders 60. The cell carrier 58 moves on an oval path, i.e. the cell carrier 58 lifts a cell in the middle, then transports it one position further, then moves downwards to place the cell in one of the receiving positions 56, then moves slightly further downwards and finally back to the starting position. In the end region 27, the cell which is in the last receiving position 56 is then ejected via the cell carrier 58 and transferred to the turning unit 36.

As already mentioned, the cells 18 are optically scanned or electrically checked when they are in various ones of the receiving positions 56, these being only two of many possible functional and inspection tests. For optical scanning of a cell 18, openings 64 opposite one another are provided in laterally delimiting side walls 62, which allow the rotating unit 30 (FIG. 1) to rotate the cell in the receiving position 56. A code printed on the cell 18 can thus be easily optically detected.

In the second next receiving position 56, two further openings 66 are provided in the side walls 62, which make it possible to electrically contact the two poles of the cell 18 so that an electrical test can be carried out via the test unit 32.

In the next receiving position 56, rectangular cutouts 68 are provided in the side walls 62, which allow the discarding unit 34 to discard from the receiving position 56 into a container (not shown). In this case, the discarding process takes place depending on the previously carried out electrical test of the cell.

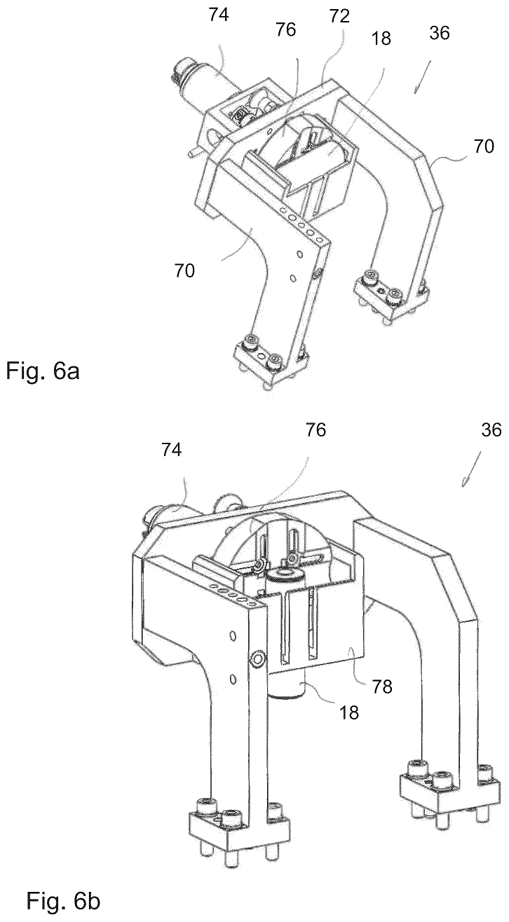

In FIGS. 6a and 6b, the turning unit 36 is shown in two different perspectives and positions of a received cell 18. The turning unit 36 has two angle supports 70 which carry a carrier plate 72. The distance between the two angle supports 70 is slightly larger than the width of the indexed conveyor 26 so that the latter can completely penetrate into the free space between the two angle supports 70. A motor 74, in particular a stepper motor with encoder, is provided on the vertical carrier plate 72 and is connected to a round holding plate 76 via a shaft (not shown). It can be seen that the motor 74 and the holding plate 76 are arranged on opposite sides of the carrier plate 72. The holding plate 76 serves to rotate a cell 18 fed in a horizontal position into a vertical position which is shown in FIG. 6b. In this case, the rotation of the holding plate 76 takes place about 90°, either clockwise or counterclockwise. The direction of rotation depends on whether the positive pole of the cell 18 should be at the bottom or at the top in its vertical position.

The holding plate 76 is at least partially surrounded by a housing 78, the upper side of which is open so that a cell 18 can enter the housing 78 from above, while the underside only has a circular opening whose diameter is slightly larger than the diameter of the cell 18. The opening is arranged centrally so that the cell can fall downwards through the opening in its vertical position. In FIG. 6b, this is indicated by a lower portion of the cell 18 protruding from the housing 78. This transfer process into the first magazine 40 takes place solely under the dead weight of the cell 18 when the vertical position is exactly reached.

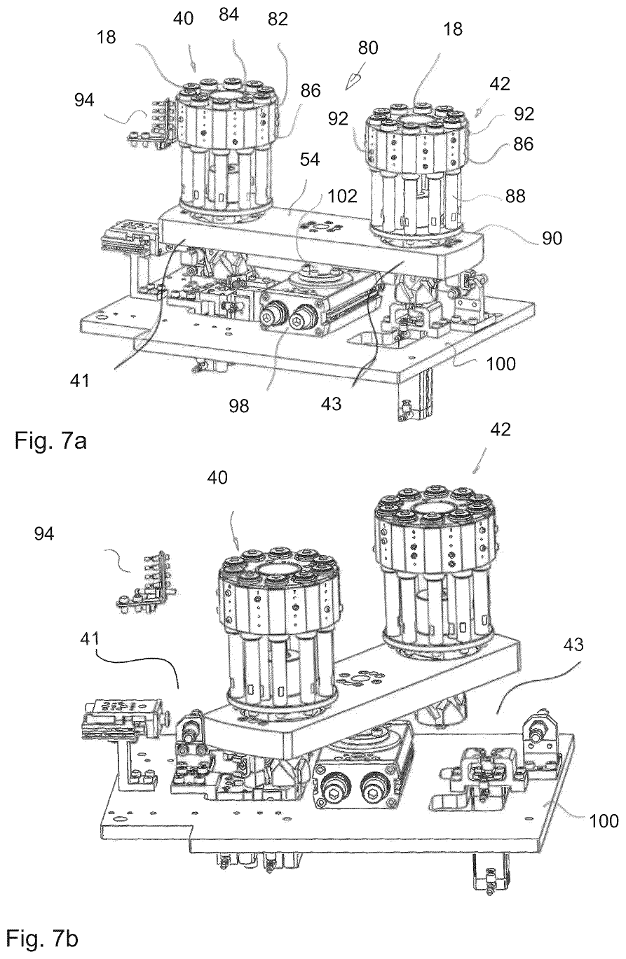

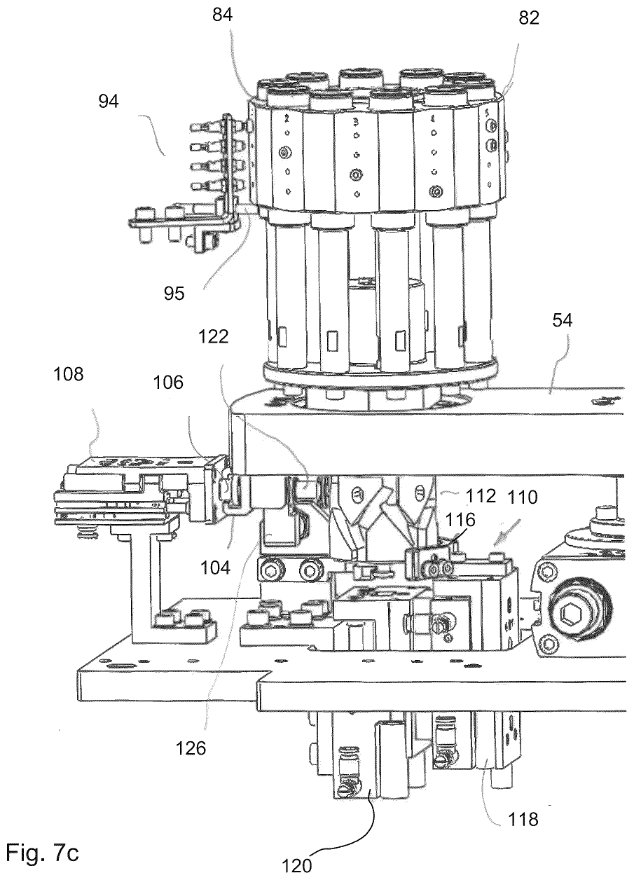

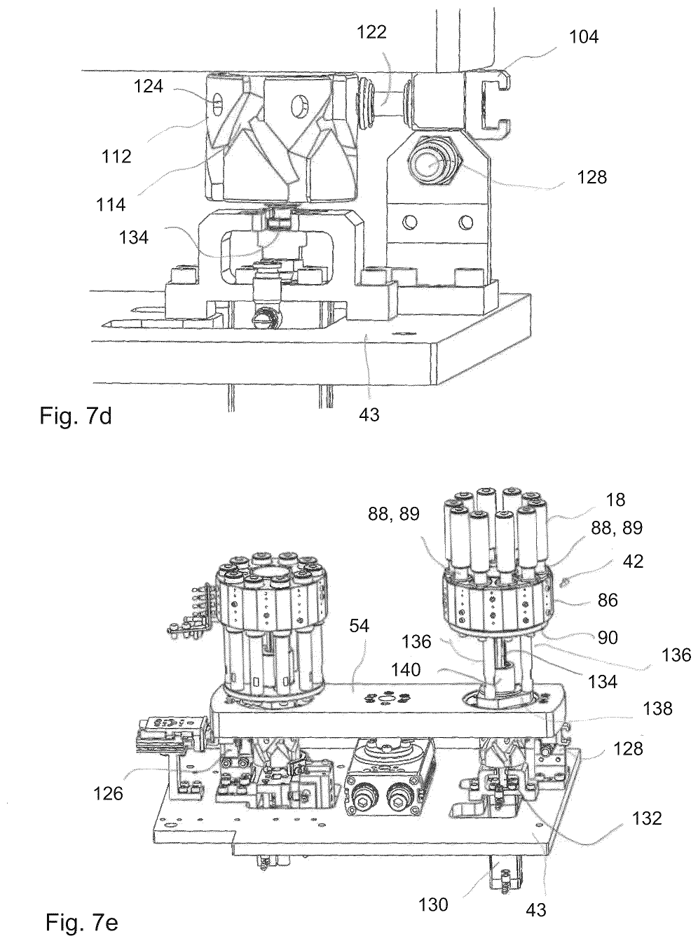

In FIGS. 7a through 7e, a magazine device 80 is explained in detail

below which, among other things, has the two magazines 40, 42 and the carrier element 54.

The magazine 40, as well as the structurally identical magazine 42, has a receiving unit 82 which has a plurality of receiving locations 84 for cells 18. In the present embodiment, the receiving unit 82 has a total of ten receiving locations 84 for ten cells 18.

The receiving unit 82 comprises an annular first element 86 which essentially serves to laterally limit the receiving locations, i.e. in the horizontal direction. In other words, each of the receiving locations 84 in the first element 86 is formed in each case by a cylindrical wall having a circular cross-section. In order to support the cells 18, located in the receiving locations 84, in a vertical direction, a second element 88 is provided which comprises a plurality of rods 89 provided on a support plate 90. The rods 89 of the second element 88 are arranged evenly spaced from one another on a circular line on the support plate 90 and are aligned coaxially with the receiving locations 84.

When constructing the receiving unit 82, it is important that the two elements 86 and 88 can be displaced relative to one another in the vertical direction. In the present embodiment, the second element 88 can be displaced upwards, for example via the support plate 90, so that the rods 89 can penetrate into the receiving locations 84 in the first element 86. The same could of course also be achieved if the first element 86 were displaced downwards. Then, too, the rods sink into the receiving locations. A combination would also be conceivable. This relative displaceability of the two elements 86 and 88 serves to move the cells 18, placed in one of the magazines 40, 42, from a receiving position into a transfer position in order to be able to thus transfer them to the transfer magazine 44. In this case, the receiving position can coincide in terms of space with the transfer position if the first element is moved downwards. If the second element is moved upwards, however, the spatial position of the cells contrastingly changes so that the receiving position and the transfer position do not spatially coincide.

Coding elements 92 are provided on the outside of the first element 86, which protrude outwards like pins. With the help of these coding elements 92 and a corresponding sensor element 94, it is possible to detect and determine which receiving location is located at which position. With the help of the functional units in the region of the indexed conveyor 26 and the sensor element 94, the system therefore knows exactly which cell is located in which pole position in a specific receiving location 84 of one of the magazines 40, 42. This information is important in particular later when filling the battery module 14.

In addition to the sensor element 94, a further sensor element 95 (FIG. 7c) is provided which can, for example, mechanically detect whether a cell 18 is located in the receiving location.

The carrier element 54 is assigned a first drive unit 98 which has, for example, an electric motor. The first drive unit 98 is mounted on a plate 100 and connected to the carrier element 54 via a shaft 102. The shaft 102 supports the carrier element 54 centrally. FIG. 7b shows that the first drive unit 98 can transfer the carrier element 54 and thus the two magazines 40, 42 from the filling position 41 into the transfer position 43 and vice versa by a rotation about 180°.

From FIG. 7c it can be seen that the carrier element 54 has a clamp element 104 at the longitudinal end on its underside, which can cooperate with a bolt 106 of a locking device 108. The bolt 106 in the locking device 108 can be extended and retracted in order to thereby achieve a locking or release between the bolt 106 and the clamp element 104. When the carrier element 54 reaches its exact position, the bolt 106 is retracted and thus locks the carrier element 54 with regard to its position. A change in the position of the carrier element 54 is then no longer possible.

As already mentioned above, in each case one cell per cycle is guided via the turning unit 36 into a receiving location 84 of the magazine 40. In order to fill all receiving locations 84, it is necessary to rotate the receiving unit 82, in the present embodiment by 36° so that the next receiving location 84 comes into the position in which the opening in the housing 78 of the turning unit 36 is exactly aligned with the corresponding receiving location 84.

It follows that the drive of the receiving unit 82 must allow exact positioning, various technical solutions being conceivable for this. In the present embodiment, this stepwise rotational movement of the receiving unit 82 is accomplished via a second drive unit 110.

This second drive unit 110 comprises a cam disk 112 which has grooves 114 in its outer side. The grooves 114 cooperate with rollers which are attached to a roller carrier or carrier 116. The carrier itself is attached to an indexing carriage 118 which in turn can be moved up and down in the vertical direction via a drive, for example a cylinder 120. When the indexing carriage 118 moves up and down, the rollers on the carrier 116 move into the grooves 114. The course of the grooves 114 is now configured such that the cam disk 112 rotates by a predefined angle of rotation during a cycle movement (movement downwards or movement upwards by a predetermined distance). This angle of rotation is determined by the distance between the receiving locations 84. If there are ten receiving locations 84 as in the present embodiment, the angle of rotation is 36°.

If the carrier element 54 is to be rotated at the end of filling, the carrier 116 with the rollers can be moved further downwards in order to disengage the rollers from the grooves.

As already mentioned above, the locking device 108 ensures, via the bolts 106, that the carrier element 54 is locked in the predetermined position. Simultaneously with the locking, a locking bolt 122 is pulled outward by being coupled to the clamp element 104. In this case, the locking bolt 122 is pulled out of a drilled hole 124 (see FIG. 7d) in the cam disk 112. This releases the cam disk for rotation. Thus, the cam disk 112, which is coupled to the receiving unit 82, can move freely.

If the carrier element 54 is now to be rotated, the locking device 108 moves the bolt 106 outwards so that the locking bolt 122 is pressed into the drilled hole 124 of the cam disk 112 by a spring (not shown). This locks the cam disk 112 and thus the receiving unit 82 in a rotationally fixed manner. This prevents accidental rotation of the receiving unit 82 during transfer into the transfer position.

In FIG. 7c, a vertically downward-facing stop plate 126 can also be seen, which is provided on the underside of the carrier element 54. The stop plate 126 cooperates with a damping element 128 that is provided on the plate 100. Two of these damping elements 128 are provided on the plate 100 in such a way that they can interact with the stop plate 126 in the filling position and/or the transfer position. Preferably, two stop plates 126 are provided on opposite sides of the carrier element 54 so that the movement path of the carrier element 54 is limited to 180°. The two damping elements 128 on the one hand limit the rotational movement and on the other hand dampen the carrier element 54 upon reaching the respective position. In FIG. 7d, the stop plate 126 is hidden behind the damping element 128, while on the opposite side, the stop plate 126 is visible, i.e. located in front of the damping element (cf. FIG. 7e).

In FIG. 7e, the second magazine 42 is shown in a state in which the cells 18 which are in a receiving position are pushed out of the receiving locations 84 and are then located in a transfer position. However, for reasons of clarity, the transfer magazine 44 is not shown in this illustration. In order to push the cells 18 out of the receiving locations 84, the support plate 90 is displaced upwards so that the rods 89 of the second element 88 penetrate into the receiving locations 84 from below and accordingly move the cells 18 upwards.

In order to move the support plate 90, a third drive unit 130 is provided which has, for example, a lifting cylinder 132 that can be moved vertically up and down. The lifting cylinder 132 can be coupled via coupling elements to a shaft 134 which extends through the cam disk 112 and is connected to the support plate 90. In this position, rod-shaped elements 136 can be seen which are connected to a plate 138 and support the first element 86. At the same time, the plate 138 and the elements 136 are connected to a hollow shaft 140 which is connected in a rotationally fixed manner to the cam disk 112. If the lifting cylinder 132 is moved upwards, this movement is transmitted to the shaft 134 which in turn moves the support plate 90 upwards. In this case, the first element 86 of the receiving unit 82 does not change its position but is rotatably held by the elements 136 and 138 and cannot be displaced up or down.

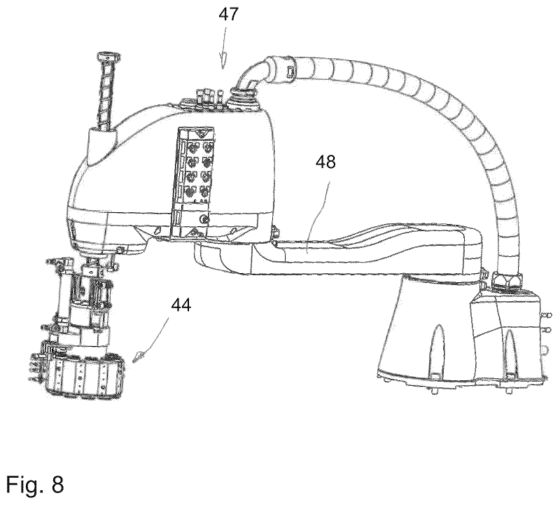

In FIG. 8, the handling device 46 is shown by way of example in the form of the robot 47. This robot 47 carries the transfer magazine 44 on its arm 48 in an exchangeable manner. The robot 47 allows a movement of the transfer magazine 44 in three dimensions, a rotation of the transfer magazine 44 also being possible. As already mentioned above, the robot 47 can first move the transfer magazine 44 into the transfer position 43 above the second magazine 42 and, after transfer of the cells 18, to the battery module 14 where each receiving location in the battery module 14 can then be approached.

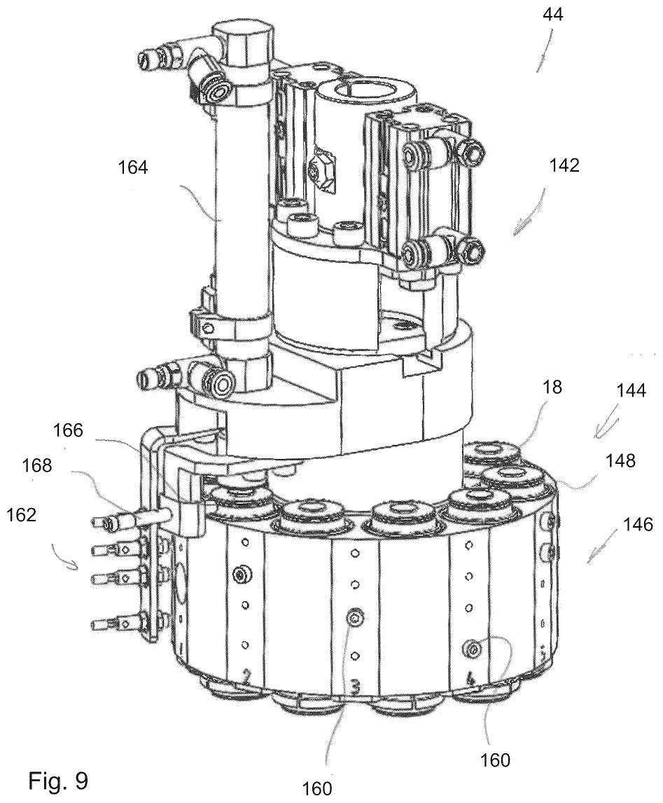

The transfer magazine 44 is shown in detail in FIG. 9. The transfer magazine 44 consists of a first portion 142 which is designed for detachable coupling to a holder on the robot arm 48. In an underlying second portion 144, a receiving unit 146 is provided which is rotatable relative to the first portion 142. The receiving unit 146 has a similar design to the receiving unit 82, i.e. to the first element 86. The receiving unit 146 has receiving locations 148 which are evenly spaced from one another on a circular line. In this case, the number of receiving locations 148 corresponds to the number of receiving locations 84 of the receiving unit 82. The receiving locations 148 are limited laterally, but in contrast to the receiving unit 82, a horizontal support comparable to the second element 88 is missing. In order to prevent the cells 18 located in the receiving locations 148 from falling out downwards, a clamping element 150 (FIG. 11) is provided in each receiving location 148. The clamping element 150 has the task of holding the cell 18 in a detachable manner. This can be achieved, for example, by frictional engagement between the clamping element 150 and the cell 18.

FIG. 11 shows an example of the clamping elements 150. Shown is a unit 152 which has bushing-shaped elements 154 with clamping elements 150 adjoining them in the longitudinal direction. The number of the elements 154 and their dimensions are adapted to the receiving locations 148. In other words, the elements 154 of the unit 152 can be inserted, in particular pushed, into the receiving locations 148 of the receiving unit 146.

The cell 18 is clamped by means of radially movable tongues 156 which protrude slightly inwards and are pressed outwards in the radial direction upon insertion of a cell 18. If the tongues 156 are accordingly designed, the resulting clamping force is sufficient to hold the cell 18 in the receiving location 148.

Like the receiving unit 82, the receiving unit 146 also has coding elements 160 (FIG. 9) on its outer surface, which make each receiving location 148 uniquely identifiable. The coding elements 160 are scanned by a corresponding sensor 162.

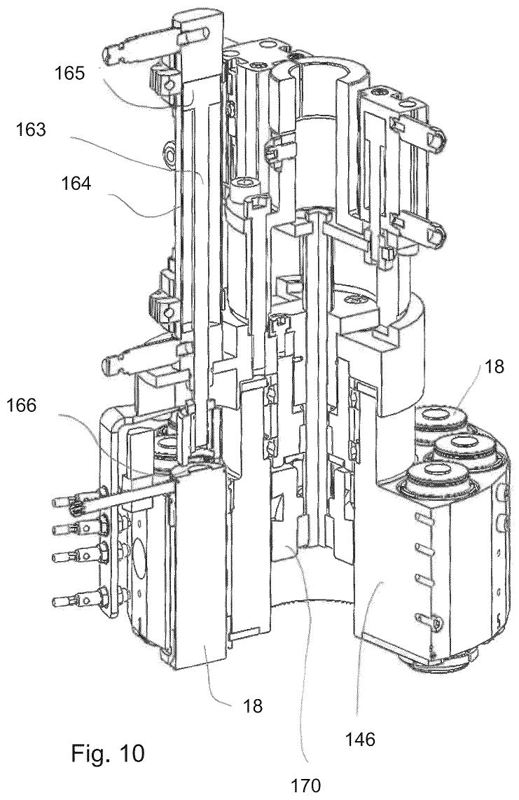

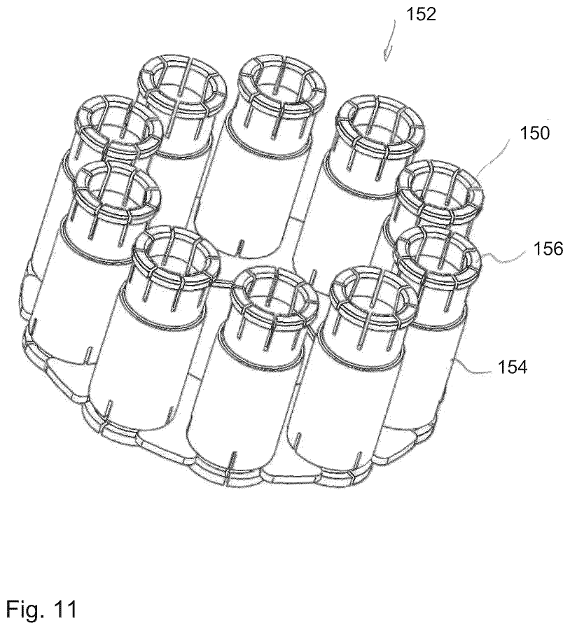

As already explained at the outset, one cell 18 is ejected from the transfer magazine 44 at a time. For this purpose, an ejection unit comprising an ejection cylinder 164, a piston 165 and a piston rod 163 is provided (FIG. 10), the ejection unit being attached to the first portion 142. The receiving unit 146 is therefore rotatable relative to the ejection cylinder 164. On the underside of the ejection cylinder 164, i.e. the piston rod 163, a contact element 166 is provided which can eject an underlying cell 18 downwards out of the receiving location 148 by means of a lifting movement.

In order to detect whether a cell 18 is located below the contact element 166, a further sensor 168 (FIG. 9) is provided which for example mechanically detects whether a cell 18 is present in the receiving location 148.

By rotating the receiving unit 146, it is possible to bring each receiving location 148 under the contact element 166 in order to eject the corresponding cell 18. The rotation of the receiving unit 146 about the angular range that is spanned by two adjacent receiving locations 148 can be carried out in different ways via a drive unit. In the present embodiment, a cam disk 170 is also provided (see FIG. 10) in which grooves are formed in which rollers run. In the present embodiment, the cam disk 170 is moved up and down, while the rollers are fixedly connected to the receiving unit 146. This movement and the shape of the grooves result in a movement of the cam disk and thus of the receiving unit 146 about a predetermined angle of rotation. The up and down movement of the cam disk can be carried out in this case via a lifting cylinder. Of course, it would also be conceivable to move the rollers up and down instead of the cam disk 170.

In summary, the above description shows that the system for filling an end product, for example a battery module, is constructed in a simple manner and allows rapid filling. In particular, the interaction of at least two magazines and the transfer magazine on the robot allows the end product to be filled without interruption and very flexibly. In particular, filling the battery module with individual cells, and not with a plurality of cells at the same time, makes the system flexible, since any arrangement of cells in the battery module can be easily achieved. In addition, the cell 18 can be controllably inserted into the battery module with the desired pole position. The system therefore allows any desired configuration of cells in the battery module.

What is claimed is:

1. A system for handling components, comprising:
a magazine device which has a carrier element and at least two magazines arranged thereon, wherein each magazine is displaceably held on the carrier element, and each magazine has a receiving unit with a plurality of receiving locations that are each for one of the components,
a first drive unit which is coupled to the carrier element in order to move the magazines into a filling position, and into a transfer position; and
a filling unit which is designed to bring one of the components into one of the receiving locations of one of the magazines positioned in the filling position;
wherein each receiving location is assigned a first element for lateral support of one of the components held in the receiving location and a second element for vertical support of the one component; and
wherein the first element and the second element are displaceable relative to one another in order to bring the one component held in the receiving location into a transfer position in which the one component can be received by a downstream handling device.

2. The system according to claim 1, further comprising a second drive unit which is designed to move at least the receiving unit of the magazine in the filling position further by one receiving location relative to the filling unit.

3. The system according to claim 2, further comprising a third drive unit which is associated with the second element in order to displace the second element vertically and relative to the first element.

4. The system according to claim 3, wherein at least one of the second drive unit and the third drive unit has a coupling element which can be detachably coupled to a coupling counterpart on the carrier element.

5. The system according to claim 3, wherein at least one of the second drive unit and the third drive unit is fixedly attached to the carrier element.

6. The system according to claim 4, wherein the coupling counterpart of the second drive unit is a cam disk, the coupling element is a roller holder with one or more rollers, and the cam disk and thus the receiving unit are rotatable by one position by vertically moving the roller holder up and down.

7. The system according to claim 6, further comprising a shaft which transmits the rotational movement of the cam disk to the receiving unit.

8. The system according to claim 7, wherein the coupling counterpart of the third drive unit is a support surface of a transmission element which cooperates with the second element of the receiving unit, and the coupling element is vertically displaceable so that the lifting movement of the coupling element causes a corresponding movement of the transmission element and thus of the second element.

9. The system according to claim 8, wherein the second element has a support unit and rods provided thereon, the transmission element being connected to the support unit.

10. The system according to claim 8, wherein the transmission element is formed by the shaft.

11. The system according to claim 1, wherein the carrier element is a rectangular plate on which two of the magazines are provided at opposite ends of the plate.

12. The system according to claim 1, wherein the carrier element is a round plate, more than two of the magazines being provided in an outer edge region of the plate.

13. The system according to claim 2, wherein the first element is an annular element, each receiving location having at least partially vertically extending inner surfaces for lateral support of one of the components and being open at its top and bottom.

14. A system for relocating components, having:
a handling device, and
a transfer magazine which can be coupled to the handling device and can be moved thereby in at least two dimensions and has:
a receiving unit that comprises a plurality of receiving locations for the components;
an ejection unit that is designed to eject downwards one of the components received in one of the receiving locations; and
a first drive unit which is designed to move at least one of the ejection unit and the receiving unit relative to the other in order to be able to assign the ejection unit to each receiving location.

15. The system according to claim 14, wherein the handling device is a robot having a robot arm, the transfer magazine being detachably attached to the robot arm, and the transfer magazine being movable from a receiving position into a first placing position and then into further placing positions.

16. The system according to claim 14, wherein each receiving location is assigned a holding or clamping element and is designed to hold one of the components in the receiving location.

17. The system according to claim 14, wherein the ejection unit has a cylinder having a piston and a piston rod, the piston rod being able to be brought into contact with one of the components in order to eject it.

18. A method for handling components, comprising:
inserting a plurality of components one after the other into individual receiving locations of a first magazine which is positioned in a filling position, wherein after each insertion of a cell, the first magazine is moved;
transferring all components of a second magazine which is positioned in a transfer position to a handling device during the filling of the first magazine; and
moving the filled first magazine into the transfer position and simultaneously moving the emptied second magazine into the filling position.

19. A method for relocating components, comprising:
simultaneously transferring a plurality of components into a transfer magazine which is held by a handling device and positioned in a receiving position;
moving the transfer magazine over an end product having a plurality of receiving locations for components; and
delivering the components from the transfer magazine into a defined receiving location in the end product one at a time, and then moving the transfer magazine to the next receiving location, until all the components in the transfer magazine have been delivered or the end product is completely filled.
